(19) United States
(12) Patent Application Publication
(10) Pub. No.: US 2008/0027959 A1
(43) Pub. Date: Jan. 31, 2008

(54) System and method for automatic application management

(76) Inventor: Joseph A. Coha, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/493,787

(22) Filed: Jul. 25, 2006

(51) Int. Cl. G06F 7/00

(52) U.S. Cl. 707/101

(57) ABSTRACT

A system and computer implemented method for dynamic management of an application. The system includes an application transformer configured to work symbiotically with a computer executable application, to monitor and control both the application and the application transformer including resource allocation associated with both the application and the application transformer, wherein the application transformer is configured to dynamically control the application and the application transformer without requiring a central management system or central resource control utility.

### FIELD OF THE INVENTION

The present invention relates to the field of application management. Specifically, embodiments of the present invention relate to decentralized automatic application management.

### BACKGROUND OF THE INVENTION

Application performance, correctness, and resource management imposes a hefty toll on IT staff and network infrastructure. Currently, deployment environments separate the management from the managed entities (e.g., computer executable applications). Isolation results in increased complexity because a centralized management unit must monitor and control a number of applications simultaneously.

Configuration requirements, including establishment and distribution of policies, metric filtering and alarming and deployment of correct types/versions of any required agents begin to make management of the management system a management problem itself. Additionally, users become frustrated at the lack of coordination between management systems and resource control utilities, the latter sometimes referred to as work load management systems. The result is a system that is too complex to efficiently manage applications.

### SUMMARY OF THE INVENTION

A system and computer implemented method for dynamic and automatic management of an application and sets of multiple applications are disclosed. The system includes an application transformer configured to work symbiotically with a computer executable application, to monitor and control both the application and the application transformer including resource allocation associated with both the application and the application transformer, wherein the application transformer is configured to dynamically control the application and the application transformer without requiring a central management system or central resource control utility.

### BRIEF DESCRIPTION OF THE DRAWINGS

The above and other objects and advantages of the present invention will be more readily appreciated from the following detailed description when read in conjunction with the accompanying drawings, wherein:

FIG. 1 is a block diagram of an exemplary appbot in accordance with embodiments of the present invention.

FIG. 2 is a block diagram of an exemplary interaction between an application and an application transformer forming an appbot in accordance with embodiments of the present invention.

FIG. 3 is a flow diagram of an exemplary computer implemented method for automatic application management in accordance with embodiments of the present invention.

FIG. 4 is a block diagram of an exemplary computer system, which can be used as a platform for embodiments of the present invention.

### DETAILED DESCRIPTION OF THE INVENTION

Reference will now be made in detail to embodiments of the present invention, a system and method for automatic application management, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

### Overview

Conventional application management separates the management environment from the managed applications (e.g., users' applications). Embodiments of the present invention unite the management environment and applications into a single collaborative unit without the required use of a centralized management system.

A system and computer implemented method for dynamic and automatic management of an application and sets of multiple applications are disclosed. The system includes an application transformer configured to work in conjunction with a computer executable application to create a unified application and management system, the appbot. The appbot monitors and controls the work associated with the appbot, wherein the application transformer is configured to dynamically control the pair of the application and application transformer without a central management system or central resource control utility (yet can integrate automatically with any available).

The application transformer loads required capabilities automatically and when in a steady state may include a data collector; the intelligence to analyze and control a) the work performed b) the resources used and c) the resources available; a policy manager configured to determine a baseline policy associated with the application (though this can be learned if no baseline policy exists); a policy modifier to automatically modify the baseline policy in response to additional information collected while monitoring the actions of the application; the ability to autonomously control the external resources required by the application to conform to the established policies; and dynamic, flexible, adaptable communication to support interactions between appbots or between appbots and any other outside entity. Appbots work together collaboratively to optimize global resource usage while not violating an individual appbot's policies.

More specifically, embodiments of the present invention automate diagnosis and resolution of performance and correctness problems associated with applications based on analysis of application metrics. Embodiments of the present invention include the concept of an appbot (application robot) a self managed application that performs automatic problem diagnosis and solution (i.e., application management) and performs requests for additional required resources and the return of unused resources (i.e., resource management). Appbots work collaboratively to optimize global resource usage. Automating resource management is particularly important in virtualized environments where resources can easily be reassigned to applications based on need. Self-management of external resource availability is critical for conforming to policies under conditions of rapidly changing application workloads. Embodiments of the present invention automate both problem diagnosis and resolution with a dynamic solution capable of adapting and learning.

An appbot is a single symbiotic process created at load time of an application that combines a users' application with a small addition, called the application transformer that monitors and controls the appbot process' own resource usage and performance. Initially, the application transformer has minimal capabilities, but dynamically loads additional capabilities as required. An appbot incorporates the capability to reason about resource contention, behavior patterns, and problem diagnosis using data collected about an application through monitoring, probing and/or any other data collection techniques.

In one embodiment of the invention, both the application and the application transformer are loaded at start-up. The application transformer activation may use hooks (e.g., in a Java runtime) to enable it to load first. An environment variable can be used for activation, eliminating the need for customers to modify their applications or start-up environments. When the application transformer is in a fully dormant state, only unmodified application code executes.

### Gathering Metrics (Data)

In one embodiment of the invention, the application transformer uses negligible system resources to ensure that the managed application is not unduly perturbed. Static data collection provides information about the structure of the application including, but not limited to, the application's own monitoring and control interfaces. Dynamic data collection provides information such as performance information associated with the execution of various aspects of the work performed by the application or within the overall appbot.

In one embodiment of the invention, instrumentation (e.g., probe insertion) of the application is performed to dynamically collect information. The probes collect information associated with the execution of the application. Collected information, both static and dynamic, includes a description of the application's input and output as well as detailed information about its framework and library usage and its resource utilization. In one embodiment of the invention, a seed policy is used to establish a baseline policy or set of policies associated with the application. Collected metrics can also be used to initially define the policies. Collected metrics can be used to further refine the policy and to recognize when the application's work is in violation of policies.

### Appbots

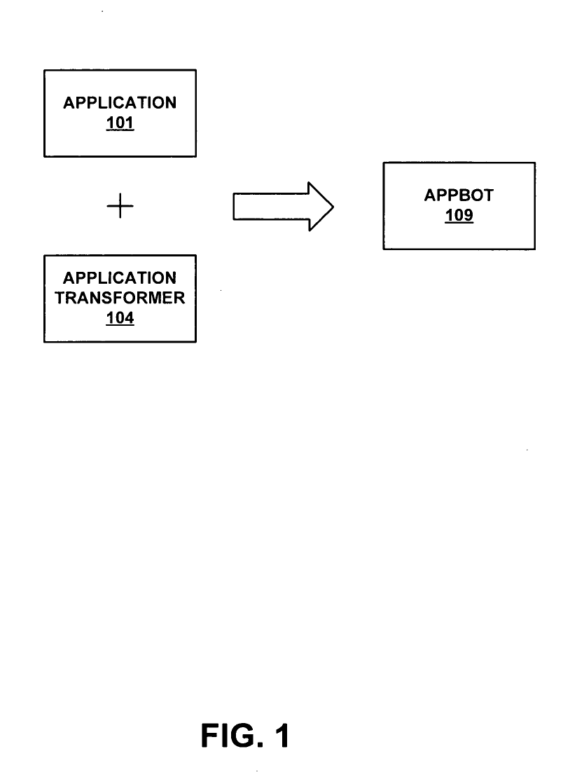

FIG. 1 is a block diagram of an exemplary appbot 109 in accordance with embodiments of the present invention. In one embodiment of the present invention, an application transformer 104 is combined with application 101 (e.g., at runtime) to form the appbot 109. The application transformer 104 monitors and controls the entire appbot's own resource usage and performance. This is the unification of the application and the application management, now both managed in the same context.

The appbot 109 uses knowledge about resource contention, behavior patterns and problem diagnosis to form a baseline policy or set of policies for the work done by the application. This information can be directly observed or can be accessed from any number of sources. For example, the information can be gathered from other appbots (leveraging inter-appbot communication), or over a network (such as the Internet) or from a persistent data store that contains stored policies.

A plurality of appbots can be communicatively coupled to form a peer-to-peer communication environment to produce a community of collaborating, cooperating appbots. In one embodiment, an application transformer 104 is generic and can be used to control and monitor any number of different applications. Although an implementation of an appbot may initially not “know” much about a particular application, the appbot has the ability to learn about itself and the surrounding environment. In one embodiment, appbots can dynamically update themselves using the dynamic updater 239.

In one embodiment of the invention, both the application 101 and the application transformer 104 are loaded at application start-up (though not required). Application transformer 104 activation may use hooks (e.g., in a Java runtime) to enable it to load first. In one embodiment, an environment variable can be used for activation which eliminates the need to modify start-up items, start-up configuration (e.g., scripts), or modify the application 101.

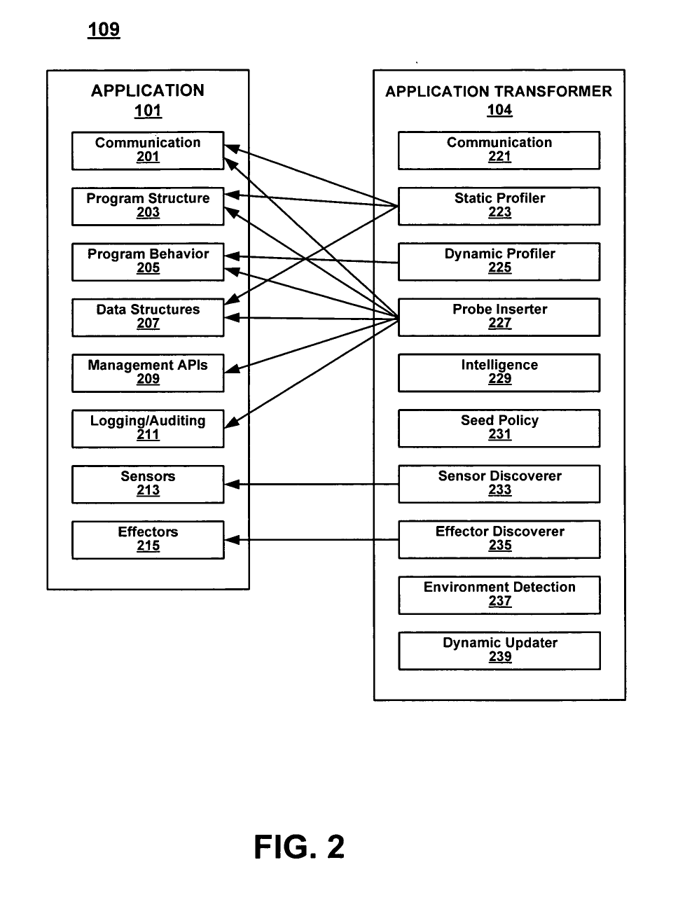

FIG. 2 is a block diagram of an exemplary interaction between an application 101 and an application transformer 104 forming an appbot 109 in accordance with embodiments of the present invention. As stated above, an appbot is an application 101 combined with an application transformer to create a single symbiotic process which can be called an appbot 109.

In one embodiment of the invention, the application may include some of the following logical and physical units including, but not limited to, communication 201, a program structure 203, a program behavior 205, data structures 207, management APIs 209, logging and auditing 211, sensors 213 (that monitor performance), and effectors 215 (that can be used to modify program behavior). These application units represent both the application and some of these, such as the effectors and sensors, allow controlling and monitoring, respectively, of application 101.

The application transformer 104 may include some of the following logical and physical units including, but not limited to, communication 221, a static profiler 223, a dynamic profiler 225, a probe inserter 227, intelligence 229, a seed policy 231, a sensor discoverer 233, an effector discoverer 235, an environment detector 237 and a dynamic updater 239. In one embodiment of the invention, a small subset of these may be the application transformer, with any other required units loaded into the executing process as required.

In one embodiment of the invention, the static profiler 223 collects data about the components and the structure of the application 101, represented by communication 201, the program structure 203, and the data structures 207 of the application 101. The static data collector 203 collects information about the application 101 to address high-level questions such as “Who am I,” “What am I,” “Where am I,” “With whom can I communicate,” etc. The application transformer 104 uses the static data and introspection to look up information about and reason about the entire appbot environment 109 using the application transformer's intelligence 229 component. The information used by the intelligence 229 component includes the framework and components loaded, the management interfaces 209 supported by the application 101, logging interfaces 211, and internal data structures 207, including queues, pools, buffers, and known data structures for specific types/classes of applications. Although the application 101 is the focus in the preceding text, the application transformer 104 also manages itself using the same mechanism, unifying the application and its management as a single manageable entity. The external resources available to the application 101 and application transformer 104 are also managed in the same unified manner within the appbot.

The dynamic profiler 225 collects data from the program behavior 205 of the application 101 and the appbot 109 itself. In one embodiment of the invention, the dynamic profiler 225 of the application transformer 104 dynamically collects increasingly detailed levels of application performance information about the program behavior 205 of the application 101. In one embodiment of the invention, new instructions are inserted into the existing stream of instructions, in a Java environment, this is known as bytecode instrumentation. This is also referred to as probe insertion.

Probe insertion is used to dynamically insert instructions into the application 101 portion of the appbot 109 to collect additional detailed information about the program's execution. In one embodiment of the invention, the probe inserter 227 modifies the communication 210, the program structure 203, the program behavior 205, the data structures 207, the management APIs 209 and the logging/auditing 211 of the application 101. Likewise, the probe inserter 227 can modify components of the application transformer 104 of the appbot 109.

In one embodiment of the invention, lightweight sampling is used by the dynamic profiler 225 to analyze the application 101 executing within the appbot 109 and provide a high level overview of the work being done in the application 101, including where the work is being done and the resource utilization associated with the work.

In another embodiment of the invention, ephemeral probes are inserted to dynamically instrument the application code associated with the application 101 to collect detailed information. It is appreciated that probes can dynamically change, as needed. For example, suppose the application's CPU usage is being monitored and the sampling threads record that there has been a change to the “hot path” through the application. The profiling thread can then back out the instrumentation in the previous “hot path” and add instrumentation to the new one. Note that the appbot manages these decisions independently of any control coming from outside the appbot 109. Embodiments of the present invention add and remove probes dynamically. This allows flexibility to answer specific questions about the application's execution even as the data driving that application's work changes.

Collected information, both static and dynamic includes high-level descriptions of the application's input and output as well as detailed information about framework, library and resource usage associated with the application 101. And, one embodiment of the invention can collect such information for the entire appbot 109.

In one embodiment of the invention, the application transformer 104 uses the static and dynamic collected information to perform more complex data analysis. For example, the application transformer looks for patterns in the data to correlate performance with resource utilization. In one embodiment, a transaction rate can be calculated by monitoring input and output associated with the application 101. When input begins to exceed output, the application transformer can check resource utilization (e.g., CPU usage, memory usage, etc.) to estimate an amount of additional resource required to meet policies associated with required service levels. Using these techniques allows the application transformer 104 to “learn” and characterize the application 101.

The application transformer 104 of the appbot 109 is designed to interact with its environment and support is available for bi-directional discovery. For example, both the discovery of the appbot 109 by another process and queries from the appbot 109 to discover other processes are supported. The discovery process enables communication support for the appbot 109 to request additional resources, such as updates for the application 101 or the application transformer 104. In addition, others can discover an appbot's presence using resources such as standard Web Services because appbot 109 can register in a shared registry. Much of this work is done in the environment detection 237.

The appbot's recognition of management systems and resource control utilities in its environment, using environment detection 237, enables the appbot to discover or negotiate a communication protocol with those systems. Similarly, appbots can negotiate communication with any other discovered entity. The application transformer 104 can convert any data format that the application 101 component uses to generate metrics into a format that is recognized by an external application management system or an external resource control utility. In one embodiment of the invention, the application transformer 104 performs automatic communication protocol recognition which allows for rapid adoption of new communication protocols. In one embodiment, the dynamic updater 239 facilitates updating the appbot to load any code required to use the new communication protocols. In one embodiment, the probe inserter 227 dynamically modifies existing code to support the new communication protocols.

In one embodiment of the invention, appbots discover each other and communicate peer-to-peer. Inter-appbot communication allows individual appbots to federate or work together in a loosely coupled fashion. Collaboration includes sharing information about the environment, establishing a repository for repeatedly accessed information, and/or sharing a knowledge base, such as a set of pattern diagnosis pairs or policies.

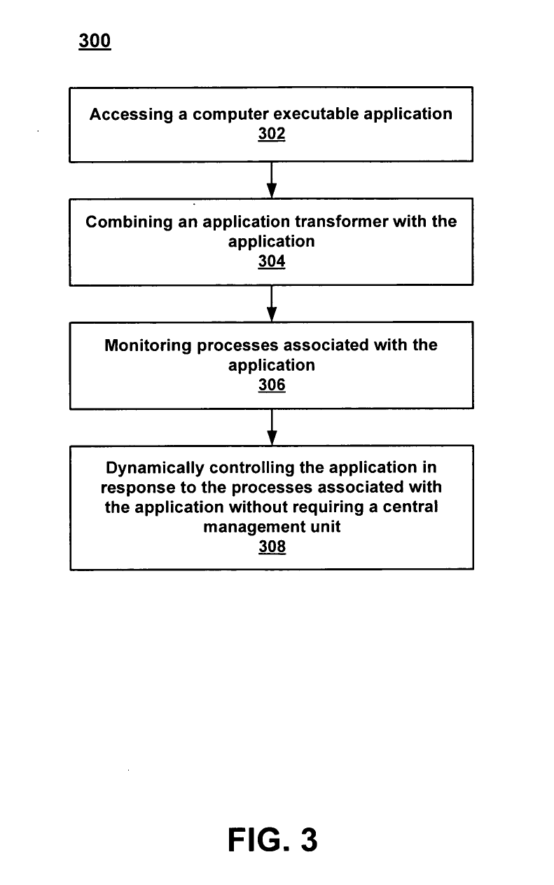

FIG. 3 is a flow diagram of an exemplary computer implemented method 300 for automatic application management in accordance with embodiments of the present invention.

At 302, method 300 includes accessing a computer executable application. In one embodiment of the invention, the application is data-driven, executing in a managed runtime environment. In one embodiment, the application is accessed locally, however, it is appreciated that the application may reside remotely (e.g., accessed from a grid computing network).

At 304, method 300 includes combining the application with an application transformer. In one embodiment, the application transformer monitors and controls the work and resource management associated with the application in 302. In one embodiment of the invention, the combination of the application and the application transformer forms an appbot 304.

At 306, method 300 includes monitoring processes associated with the application. In one embodiment of the invention, the application transformer “learns” the behavior of the application by dynamic and static data collection. For example, the application transformer uses the collected static and dynamic information to perform more complex data analysis, such as performance predictions, resource requirements and problem diagnosis and problem resolution.

At 308, method 300 includes dynamically controlling the application in response to (a) changing workloads, (b) changing behavior of other collaborating processes that are required to complete work assigned to them and return data necessary to complete work in the application, and/or (c) changes to the application's environment that impact the application's speed or ability to complete work, all without the use of a centralized management system or resource control utility. It is appreciated that the appbot of the present invention is a standalone entity that can operate without a central authority. Methods for controlling the application may include throttling resource consumption (internal), allocation or deallocation of resources available (external), problem identification/resolution, peer-to-peer communication, instrumentation of the application code, insertion/removal of probes in the application code, dynamic updating of the application or application transformer of the appbot, or any other operation that modifies or improves the “normal” operation of the application.

### Trading-Based Bid/Accept Application Management

For an environment of autonomous, collaborating appbots, embodiments of the present invention use, but are not restricted to using, a trading-based bid/accept interaction model to replace strict policy-driven resource allocation. In this model, the appbot bids for resources using “currency” it earns by completeing work. The value of the appbot's bid is scaled by the resource control utility based on the completed work's priority. In one embodiment of the invention, the priorites can be abstracted from the knowledge required by the appbot to bid for resources. The resource control utility considers the bids from all appbots making bids.

The resource control utility assigns resources in proportion to the received bid. It may appear that a greedy strategy would benefit one appbot over another. However, in one embodiment, the system prevents an appbot from accumulating and hoarding resources if the appbot does not do the work required to fulfill and hold resource bids. Overall, the resource control utility will globally optimize the resource allocation among appbots. In one embodiment of the invention, a set of cooperating appbots share resources amongst themselves.

An advantage of the monetizaton of resources is that billing becomes easier. The bid/accept for each of the appbots can be easily monitored and attributed. The monetary value corresponds directly to the resource usage by one appbot. Using the application transformer as a proxy, in one embodiment through the use of the communication 221 of the application transformer 104 and modification of the application's 101 communication 201 by the application transformer's 104 probe inserter 227, a transaction tracer can attribute a monetary value to a user.

In essence, a tracer (a type of inserted probe) matches a user (or group) with a quantity of resources used by an appbot on behalf of the user. Similarly, in one embodiment, the application transformer creates a different type of proxy to prioritze requests made of the appbot, providing an easy solution for implementing different levels of service to different users. Such proxies provide powerful mechanisms for modifying and controlling the appbot.

To solve the problem of resource allocation, in one embodiment, a distributed, market-based, economically efficient, low-latency resource allocation system based on an Auction Share scheduling algorithm is used. System users bid continuously for virtualized, proportional resources, which removes the need to negotiate resource allocation. Users obtain credits from the “bank” and submit bids to an auctioneer. Resources are allocated in proportion to each user's weight. Cheaters are discouraged by including the cost effectiveness of the work done in the calculation of resource distribution. The allocation of resources will automatically favor the most cost effective users.

### Policy and Learning

Embodiments of the present invention can use an initial policy, called a seed policy, that the application transformer generates from a small set of rules packaged with the appbot combined with any information that the appbot might obtain from an exisitng management environment.

As the appbot learns more about its environment, it can interact with its peers to obtain additional information. When the load increases on the appbot, the application transformer can use performance data, as well as throughput and user load data, to do additional reasoning about the constraints and requirements for work completion. If aberrant behavior occurs, the benefits of locality aid in rapid diagnosis. Using information available locally or from queries to other appbots, the application transformer searches for a known solution to the problem, or, alternatively, the code required to determine the root cause of the problem.

Information from static analysis performed by the application transformer portion of the appbot on the appbot itself helps the appbot to determine whether an appropriate control point can be found in the application component of the appbot. If found, the application transformer attempts to fix the problem. If no control point is found, or the attempted fix fails, then an event could be sent to any existing external management system. Note that the management system can also be running as an appbot in this environment, providing automatic self-management of the system management system. The on-going policy evolution of the appbot continues to take place as a negotiation among its peers as well as between the appbot and any system management appbot peer (or resource control utility appbot peer).

### Exemplary Computer System

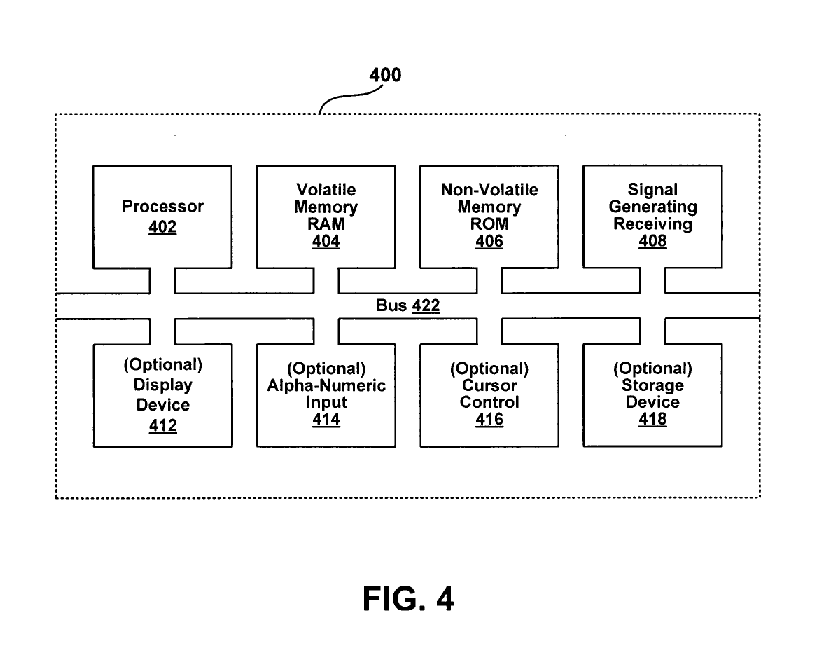

With reference to FIG. 4, portions of the present invention are comprised of computer-readable and computer-executable instructions that reside, for example, in computer system 400, which may be used as a part of a general-purpose computer network (not shown). It is appreciated that computer system 400 of FIG. 4 is exemplary only and that the present invention can operate within a number of different computer systems including general-purpose computer systems, embedded computer systems, laptop computer systems, hand-held computer systems, and stand-alone computer systems.

In the present embodiment, computer system 400 includes an address/data bus 422 for conveying digital information between the various components, a central processor unit (CPU) 402 for processing the digital information and instructions, a volatile main memory 404 comprised of volatile random access memory (RAM) for storing the digital information and instructions, and a non-volatile read only memory (ROM) 406 for storing information and instructions of a more permanent nature. In addition, computer system 400 may also include a data storage device 418 (e.g., a magnetic, optical, floppy, or tape drive or the like) for storing vast amounts of data. It should be noted that the software program for outputting information of the present invention can be stored either in volatile memory 404, data storage device 418, or in an external storage device (not shown).

Devices which are optionally coupled to computer system 400 include a display device 412 for displaying information to a computer user, an alpha-numeric input device 414 (e.g., a keyboard), and a cursor control device 416 (e.g., mouse, trackball, light pen, etc.) for inputting data, selections, updates, etc. Computer system 400 can also include a mechanism for emitting an audible signal (not shown).

Furthermore, computer system 400 can include an input/output (I/O) signal unit (e.g., interface) 408 for interfacing with a peripheral device (e.g., a printer, a computer network, modem, mass storage device, etc.). Accordingly, computer system 400 may be coupled in a network, such as a client/server environment, whereby a number of clients (e.g., personal computers, workstations, portable computers, minicomputers, terminals, etc.) are used to run processes for performing desired tasks (e.g., printing, outputting information, etc.).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A system for automatic application management comprising:
an application transformer configured to work symbiotically with a computer executable application, to monitor and control both said application and said application transformer including resource allocation associated with both said application and said application transformer, wherein said application transformer is configured to dynamically control said application and said application transformer without requiring a central management system or central resource control utility.

2. The system as described in claim 1 wherein said application transformer comprises:
a data collector for collecting data associated with said application and for collecting data associated with said application transformer;
a controller for controlling work performed, resources used and resources available associated with said application and said application transformer;
a policy manager configured to determine a baseline policy associated with said application and said application transformer;
a policy modifier configured to automatically modify said baseline policy in response to said data associated with said application and said data associated with said application transformer;
a control mechanism for autonomously controlling external resources available to said application and said application transformer; and
a communicator configured to communicate with other application/application transformers or other external entities.

3. The system as described in claim 2 wherein said data collector is configured to collect data associated with work performed by said application and by said application transformer and resources used by said application and said application transformer.

4. The system as described in claim 1 further comprising:
an appbot created at start-up of said application, said appbot comprising a single symbiotic process combining said application with said application transformer.

5. The system as described in claim 4 wherein said appbot is configured to collaborate with a plurality of appbots to maximize efficiency of resource usage associated with said plurality of appbots.

6. The system as described in claim 1 wherein said application transformer is configured to modify application code associated with said application in response to said monitoring of said processes associated with said application.

7. The system as described in claim 1 wherein said application transformer is configured to intercept and dynamically modify inputs and outputs associated with said application.

8. The system as described in claim 1 wherein said application transformer is generic and is configured to control and monitor a plurality of applications.

9. A computer implemented method for dynamic application management comprising:
accessing a computer executable application;
combining an application transformer with said application;
monitoring work performed and resources used by said application; and
dynamically controlling said application in response to said work performed and resources used by said application without requiring a central management unit.

10. The computer implemented method as described in claim 9 wherein said application transformer is combined with said application at start-up of said application.

11. The computer implemented method as described in claim 9 further comprising:
dynamically modifying application code associated with said application in response to said monitoring of said processes associated with said application.

12. The computer implemented method as described in claim 9 further comprising:
accessing performance information associated with said application.

13. The computer implemented method as described in claim 9 further comprising:
accessing resource usage associated with said application; and
dynamically controlling said application in response to said resource usage and dynamically controlling external resource availability associated with said application.

14. The computer implemented method as described in claim 9 further comprising:
intercepting and dynamically modifying inputs and outputs associated with said application.

15. Instructions on a computer-usable medium wherein the instructions when executed cause a computer system to perform a method for dynamic management of a computer executable application, said computer-implemented method comprising:
accessing a computer executable application;
combining an application transformer with said application;
monitoring work performed and resources used by said application; and
dynamically controlling said application in response to said work performed and resources used by said application without requiring a central management unit.

16. The computer implemented method as described in claim 15 wherein said application transformer is combined with said application at start-up of said application.

17. The computer implemented method as described in claim 15 further comprising:
dynamically modifying application code associated with said application in response to said monitoring of said processes associated with said application.

18. The computer implemented method as described in claim 15 further comprising:
accessing performance information associated with said application.

19. The computer implemented method as described in claim 15 further comprising:
accessing resource usage associated with said application; and
dynamically controlling said application in response to said resource usage and dynamically controlling external resource availability associated with said application.

20. The computer implemented method as described in claim 15 further comprising:
intercepting and dynamically modifying inputs and outputs associated with said application.
